(19) United States
(12) Patent Application Publication
(10) Pub. No.: US 2009/0223543 A1
(43) Pub. Date: Sep. 10, 2009

(54) PRODUCE CLEANING DEVICE

(76) Inventor: JOANN HERRING, Goldsboro, NC (US)

Correspondence Address: JAMES RAY & ASSOCIATES, 2640 PITCAIRN ROAD, MONROEVILLE, PA, 15146, US

(21) Appl. No.: 12/400,211

(22) Filed: Mar. 9, 2009

Related U.S. Application Data
(60) Provisional application No. 61/035,091, filed on Mar. 10, 2008.

(51) Int. Cl. B08B 3/04; B08B 13/00

(52) U.S. Cl. 134/57 R

(57) ABSTRACT

A produce cleaning device includes a housing having access mechanism for accessing an interior portion thereof. Water dispensing mechanism is connected to such housing and a source of water. First valve mechanism intermediate such source of water and such water dispensing mechanism is for turning on and off water flow. Water removal mechanism drains water from such housing. Second valve mechanism is intermediate water removal mechanism and a drain for controlling water removal. Rotatable agitating mechanism agitates water around produce within housing. A motor powers rotation of agitating mechanism. A power supply supplies power to motor, first valve mechanism, and second valve mechanism. A control mechanism enables a user to control amount of water dispensed, temperature of water, timing of water dispensing and removal, timing of agitation, and a combination thereof. A switch mechanism is disposed between control mechanism and power supply for turning power supply on and off.

### CROSS REFERENCE TO RELATED APPLICATION

This patent application is related to and claims priority from U.S. Provisional Patent Application Ser. No. 61/035,091 filed Mar. 10, 2008.

### FIELD OF THE INVENTION

The present invention relates, in general, to produce cleaning devices and, more particularly, this invention relates to a device for removing dirt, dust, debris, bacteria, insects, twigs, and the like from fruits and vegetables.

### BACKGROUND OF THE INVENTION

Prior to the conception and development of the present invention, it is generally well known in the prior art, to clean fruits and vegetables prior to cooking them, eating them, displaying them, and the like. However, washing and cleaning such fruits and vegetables can be time consuming, boring, difficult, and generally an annoying and disliked chore. Furthermore, if the cleaning is not done properly, bacteria, toxins, dirt and other debris may remain on such fruits and vegetables and eventually make those who consume such fruits and vegetables ill.

Specifically of interest to the present invention are the following: Martin, U.S. Pat. No. 5,551,461, discloses a produce washer wherein produce is supported upon a screen basket suspended within a closed cabinet. A plurality of nozzles disposed about the basket emit a filled cone of washing liquid to scour the produce and to dislodge by agitation and flotation debris there from.

Wen, U.S. Pat. No. 5,927,304, discloses a food article washer including a container for food articles and a cleaning liquid for cleaning the food articles. A basket is provided within the container for holding the food articles. A vibration device imparts vibrations to the cleaning liquid.

Rich, U.S. Pat. No. 6,508,257, discloses a hands-free, electrically operated food washing device having a fluid dispenser, such as a reservoir, a wash compartment, a motor-driven agitator, a removable food basket, and a drain for removing soiled fluid from the device.

Lyubchik, et al, U.S. Publication No. US 2006/0102193, discloses a method and apparatus for washing fruits and vegetables. The apparatus has a degassing means; a washing tank; an ultrasonic means; at least one water pumping means; a water jetting means for directing a plurality of jets of water, a holding means to facilitate passage of ultrasonic energy through the water; and a control means.

Kelly, U.S. Pat. No. 3,066,334, discloses a vegetables cleaning appliance for spraying vegetables with water while such vegetables are being agitated.

Reid, U.S. Pat. No. 4,173,051, discloses an apparatus for washing fruits and vegetables including a container for housing the food articles, an agitation system and washing system for removing undesired foreign materials from the surface of the food articles without causing bruising or damage, and a discharge system.

### SUMMARY OF THE INVENTION

The present invention provides a produce cleaning device. Such produce cleaning device includes a generally hollow housing member manufactured from a first predetermined material and having a first predetermined size and a first predetermined shape. An access means is disposed on such housing member at a predetermined location for enabling a user to selectively access an interior portion of such housing member. A source of water supplies a flow of water to such housing member via a water dispensing means which is operably connected to such housing member and such source of water for dispensing water into such interior portion of such housing member. A first valve means is connected intermediate such source of water and such water dispensing means for turning on and off a flow of water from such source of water to such housing member. A water removal means is operably connected to such housing member for draining water from within such housing member. A second valve means is disposed intermediate such water removal means and a drain for controlling water removal from such housing member. A rotatable agitating means is disposed within such housing member for agitating water around predetermined produce housed within such interior portion of such housing member. A motor is operably connected to such rotatable agitating means for powering rotation of such rotatable agitating means. A power supply is operably connected to such motor, such first valve means, and such second valve means for supplying power thereto. A control means is operably connected to at least one of such first valve means, such second valve means, such agitating means, such motor, and a combination thereof for selectively controlling at least one of an amount of water being dispensed, a temperature of such water being dispensed, timing of water dispensing, timing of water removal, timing of agitation, and a combination thereof. A switch means is operably disposed between such control means and such power supply for selectively turning such power supply on and off.

### OBJECTS OF THE INVENTION

It is, therefore, one of the primary objects of the present invention to provide a device which can wash and decontaminate a predetermined quantity of produce in place of hand washing each piece of produce individually.

Another object of the present invention is to provide a device which can clean a predetermined plurality of produce without bruising and damaging such produce.

Still another object of the present invention is to provide a device which can be utilized to remove unwanted dirt, debris, insects, dust, pollen, and the like from produce.

Yet another object of the present invention is to provide a portable device for use in washing produce thereby making preparing and consuming produce easier and more enjoyable for a user of such device.

An additional object of the present invention is to provide a machine which can wash produce for individuals who are unable to do so due to health, physical inability, arthritis, mental defects, etc.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a partial perspective view of the invention according to one embodiment of the invention.

FIG. 2 is a is a partial perspective view of the invention according to one embodiment of the invention.

FIG. 3 is a partial perspective view of the invention according to one embodiment of the invention in which the invention is illustrated connected to a sink and plugged into an electrical outlet.

FIG. 4 is a partial cutaway view of the invention taken according to one embodiment of the invention.

FIG. 5 is a partial schematic view of the invention according to one embodiment of the invention.

FIG. 6 is a partial schematic view of the invention according to one embodiment of the invention.

FIG. 7 is a partial schematic view of the back of the invention according to one embodiment of the invention in which a basket holding member holds a plurality of baskets.

FIG. 8 is a partial schematic view of the invention according to one embodiment of the invention in which the invention is being stored inside a cabinet.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

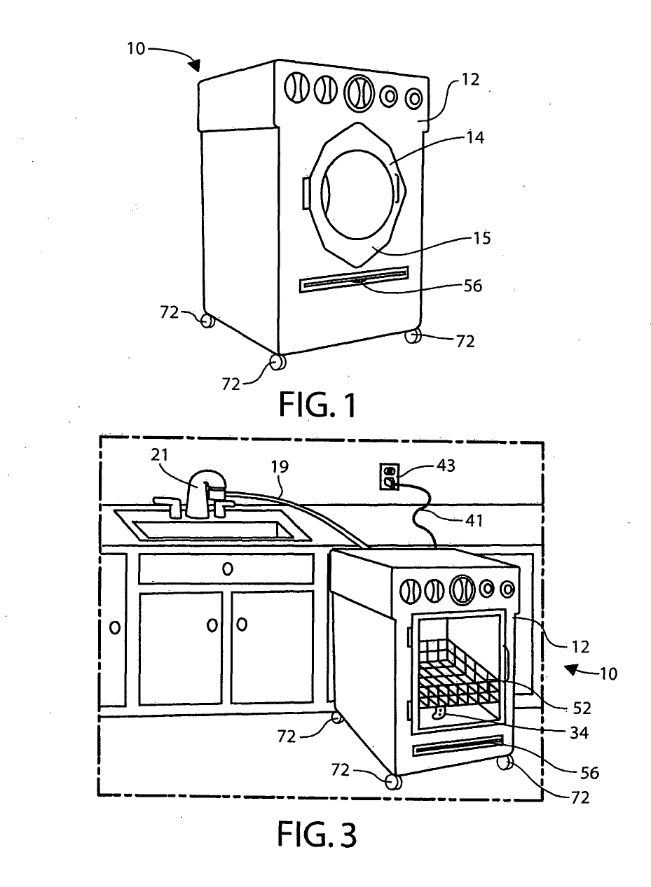

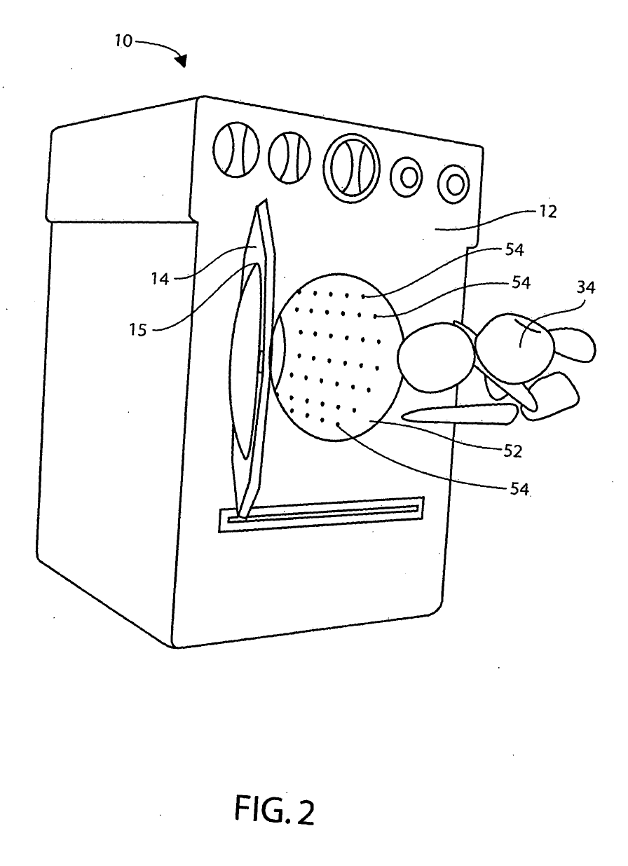

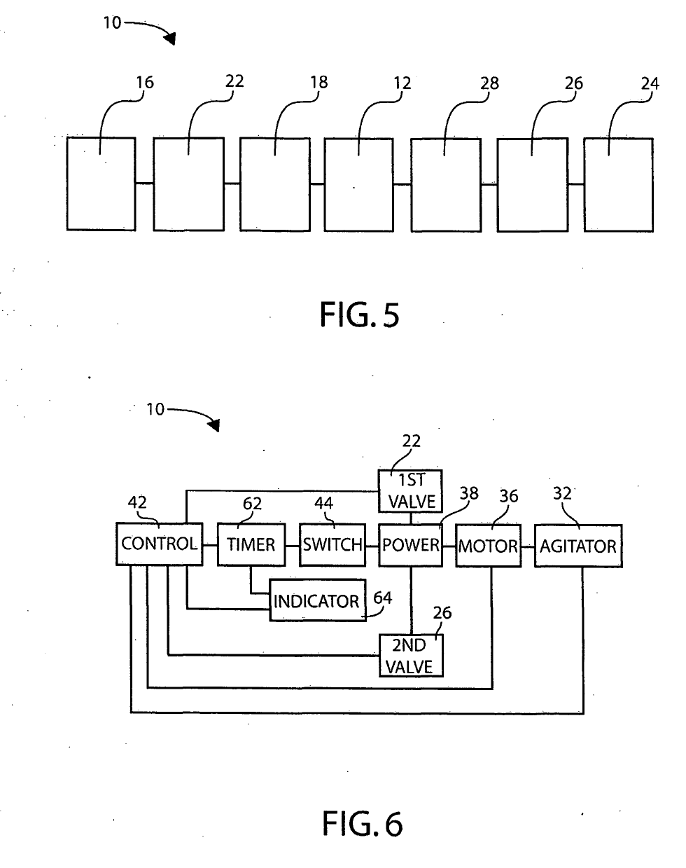

Reference is now made, more particularly, to FIGS. 1-8.

The present invention provides a produce cleaning device, generally designated 10. Such produce cleaning device 10 includes a generally hollow housing member 12 manufactured from a first predetermined material and having a first predetermined size and a first predetermined shape.

An access means 14 is disposed on such housing member 12 at a predetermined location for enabling a user (not shown) to selectively access an interior portion of such housing member 12. It is presently preferred that such access means is a door member 15 hingedly connected to such housing member 12 at a predetermined location thereon.

A source of water 16 supplies a flow of water to such housing member via a water dispensing means 18 which is operably connected to such housing member 12 and such source of water 16 for dispensing water into such interior portion of such housing member 12. It is presently preferred that such water dispensing means 18 includes a hose member 19 releasably connectable to a sink 21.

A first valve means 22 is connected intermediate such source of water 16 and such water dispensing means 18 for turning on and off a flow of water from such source of water 16 to such housing member 12.

A water removal means 24 is operably connected to such housing member 12 for draining water from within such housing member 12.

A second valve means 26 is disposed intermediate such water removal means 24 and a drain 28 for controlling water removal from such housing member 12.

A rotatable agitating means 32 is disposed within such housing member 12 for agitating water around predetermined produce 34 disposed within such interior portion of such housing member 12.

A motor 36 is operably connected to such rotatable agitating means 32 for powering rotation of such rotatable agitating means 32.

A power supply 38 is operably connected to such motor 36, such first valve means 22, and such second valve means 26 for supplying power thereto. It is presently preferred that such power supply 38 is at least one of AC and DC power. According to a preferred embodiment, such power supply 38 is AC and includes an electrical cord 41 for plugging into an electrical outlet 43. However, the device is not meant to be limited as such and such power supply 38 may be DC and may include at least one battery; preferably such at least one battery is rechargeable.

A control means 42 is operably connected to at least one of such first valve means 22, such second valve means 26, such agitating means 32, such motor 36, and a combination thereof for selectively controlling at least one of an amount of water being dispensed, a temperature of such water being dispensed, timing of water dispensing, timing of water removal, timing of agitation, and a combination thereof.

A switch means 44 is operably disposed between such control means 42 and such power supply 38 for selectively turning such power supply 38 on and off.

It is presently preferred that such device 10 further includes a basket member 52 disposed within such interior portion of such housing member 12. Such basket member 52 includes a plurality of apertures 54 disposed therethrough for passage of water and debris. Such basket member 52 is for supporting such predetermined produce at least one of thereon, therein, and a combination thereof. It is further presently preferred that such rotatable agitating means 32 is such basket member 52 and such basket member 52 is rotatably connected to such interior portion of such housing member 12. It is presently preferred that such basket member 52 is releasably disposed within such housing member. It is further presently preferred that such device 10 includes a plurality of baskets 57 each being releasably disposable within such housing member 12. It is meant that a user of such device choose the appropriate basket from such plurality of baskets 57 within which to put the specific items of produce to be washed. For example, a different basket would be used for berries, greens, broccoli, apples, etc. It is further presently preferred that a basket holding member 74 is disposed on a predetermined location on such housing member 12 for supporting such plurality of baskets 57 at least one of therein, thereon, and a combination thereof when such plurality of baskets 57 are not in use in such housing 12.

It is presently preferred that such device 10 further includes a debris collection member 56 operably connected to at least one of such water removal means 24 for collecting debris there from, such housing member 12, and a combination thereof. Preferably such debris collection member 56 is selectively removable from such at least one of such water removal means 24, such housing member 12, and a combination thereof for emptying such debris. It is meant that when a wash cycle is completed the debris collection member may be removed from the device for cleaning and then returned to its position for debris collection during the next wash cycle. The debris collection member may be a filter tray, screen, or other suitable means.

It is presently preferred that a timing means 62 is operably connected between such control means 42 and such switch means 44 for selectively terminating a predetermined wash cycle after a predetermined amount of time.

Preferably such device 10 includes an indicator means 64 disposed on such housing member 12 and operably connected to such control means 42, such timing means 62, such power supply 38, and a combination thereof, for indicating termination of such predetermined wash cycle. It is presently preferred that such indicator means 64 is at least one of a light 66, an audible alarm, and a combination thereof.

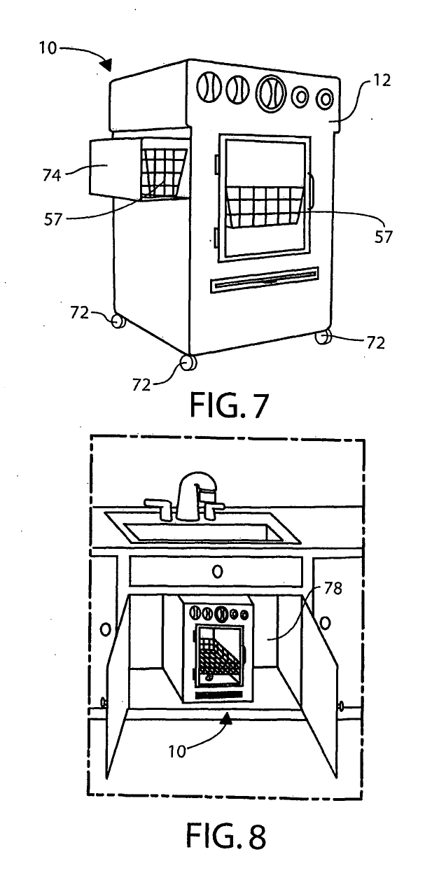

It is presently preferred that such device 10 is portable. It is presently preferred that such device 10 further includes a plurality of wheel members 72 disposed on a bottom portion of such housing member 12 for enabling a user to transport such device 10. However, the device 10 is not meant to be limited as such and may be stationary and positioned as desired by a user. Such device 10 may also be made to fit within a cabinet 78 as illustrated in FIG. 7.

It is meant that a user may attach the device to a sink and plug in the electrical cord to supply power to the device then load the device with produce and select the wash cycle which best accommodates the type of produce being washed. Such device may be used to wash produce with water alone and may also be used with a predetermined cleanser, preferably a non-toxic cleanser. Once the wash cycle is completed (indicated by the indicating means) the produce may be removed from the housing and cooked, eaten, displayed and the like. The device is meant to be about 42 inches high, about 24 inches long, and about 24 inches wide. However, the device is not meant to be limited as such and the device may be made smaller and larger as necessary to fulfill its purpose.

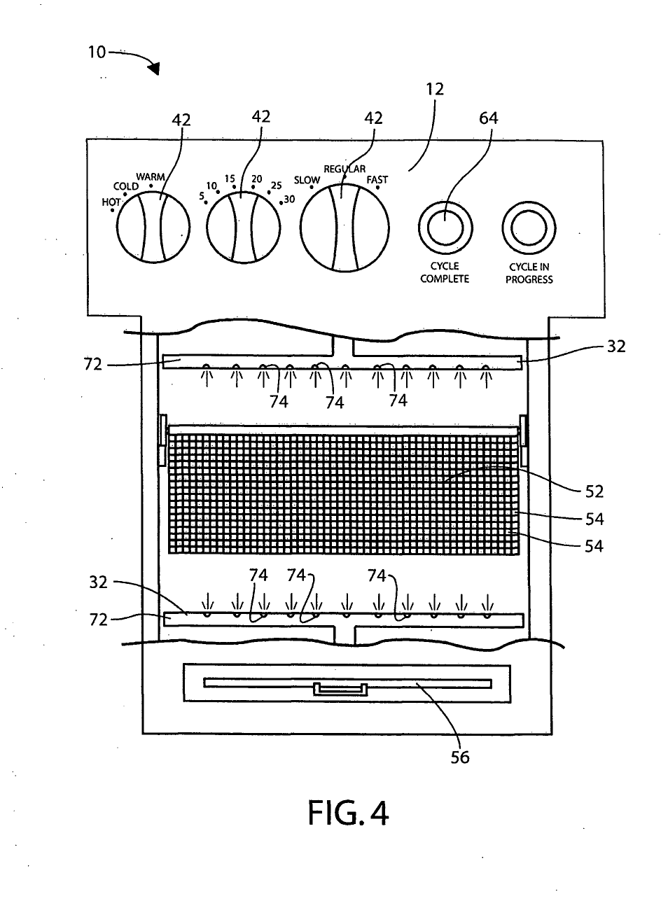

According to another embodiment, as illustrated in FIG. 4 such rotatable agitating means 32 is at least one rotating arm 72 disposed at least one of above such basket member 52, below such basket member 52, and a combination thereof, such at least one rotating arm 72 having a plurality of apertures 74 disposed therethrough at predetermined locations thereon and further being operably connected to such water dispensing means 18 such that water from such water dispensing means flows through such apertures 74.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A produce cleaning device comprising:
a. a generally hollow housing member manufactured from a first predetermined material and having a first predetermined size and a first predetermined shape;
b. an access means disposed on said housing member at a predetermined location for enabling a user to selectively access an interior portion of said housing member;
c. a source of water;
d. a water dispensing means operably connected to said housing member and said source of water for dispensing water into said interior portion of said housing member;
e. a first valve means connected intermediate said source of water and said water dispensing means for controlling turning on and off a flow of water from said source of water to said housing member;
f. a water removal means operably connected to said housing member for draining water from within said housing member;
g. a second valve means disposed intermediate said water removal means and a drain for controlling water removal from said housing member;
h. a rotatable agitating means disposed within said housing member for agitating water around predetermined produce housed within said interior portion of said housing member;
i. a motor operably connected to said rotatable agitating means for powering rotation of said rotatable agitating means;
j. a power supply operably connected to said motor, said first valve means, and said second valve means for supplying power thereto;
h. a control means operably connected to at least one of said first valve means, said second valve means, said agitating means, said motor, and a combination thereof for selectively controlling at least one of an amount of water being dispensed, a temperature of such water being dispensed, timing of water dispensing, timing of water removal, timing of agitation, and a combination thereof; and
i. a switch means operably disposed between said control means and said power supply for selectively turning said power supply on and off.

2. A produce cleaning device according to claim 1 wherein said device further includes a basket member disposed within said interior portion of said housing member, said basket member including a plurality of apertures disposed there through for passage of water and debris, said basket member for supporting such produce at least one of thereon, therein, and a combination thereof.

3. A produce cleaning device according to claim 2 wherein said basket member is releasably disposed within said interior portion of said housing member.

4. A produce cleaning device according to claim 1 wherein said access means is a door member hingedly connected to said housing member at a predetermined location thereon.

5. A produce cleaning device according to claim 1 wherein said device is portable.

6. A produce cleaning device according to claim 1 wherein said device further includes a debris collection member operably connected to at least one said water removal means for collecting debris therefrom, said housing member, and a combination thereof.

7. A produce cleaning device according to claim 6 wherein said debris collection member is selectively removable from said at least one of said water removal means, said housing member, and a combination thereof for emptying such debris.

8. A produce cleaning device according to claim 1 wherein said power supply is at least one of AC and DC power.

9. A produce cleaning device according to claim 8 wherein said power supply is AC and includes an electrical cord for plugging into an electrical outlet.

10. A produce cleaning device according to claim 8 wherein said power supply is DC and includes at least one battery.

11. A produce cleaning device according to claim 10 wherein said at least one battery is rechargeable.

12. A produce cleaning device according to claim 1 wherein said water dispensing means includes a hose member releasably connectable to a sink.

13. A produce cleaning device according to claim 1 wherein a timing means is operably connected between said control means and said switch means for selectively initiating and terminating a predetermined wash cycle after a predetermined amount of time.

14. A produce cleaning device according to claim 13 wherein said device further includes an indicator means disposed on said housing member and operably connected to said control means, said timing means, said power supply and a combination thereof, for indicating termination of a predetermined wash cycle.

15. A produce cleaning device according to claim 1 according to claim 13 wherein said indicator means is at least one of a light, an audible alarm, and a combination thereof.

16. A produce cleaning device according to claim 2 wherein said rotatable agitating means is at least one rotating arm disposed at least one of above said basket member, below said basket member, and a combination thereof, said at least one rotating arm having a plurality of apertures disposed there through at predetermined locations thereon and further being operably connected to said water dispensing means such that water from said water dispensing means flows through said apertures.

17. A produce cleaning device according to claim 2 wherein said rotatable agitating means is said basket member and said basket member is rotatably connected to said interior portion of said housing member.

18. A produce cleaning device according to claim 3 wherein said device includes a plurality of baskets each being releasably disposable within said housing member.

19. A produce cleaning device according to claim 18 wherein said device further includes a basket holding member disposed on a predetermined location on said housing member for supporting said plurality of baskets at least one of therein, thereon, and a combination thereof when said plurality of baskets are not in use in said housing member.

20. A produce cleaning device according to claim 5 wherein said produce cleaning device further includes a plurality of wheel members disposed on a bottom portion of said housing member for enabling a user to transport said device.
